(19) United States
(12) Patent Application Publication
(10) Pub. No.: US 2026/0277506 A1
(43) Pub. Date: Sep. 17, 2026

(54) IMAGE PROCESSING APPARATUS, INFORMATION PROCESSING TERMINAL, IMAGE PROCESSING SYSTEM, AND NON-TRANSITORY COMPUTER READABLE MEDIUM

(71) Applicant: FUJIFILM Business Innovation Corp, Tokyo (JP)

(72) Inventor: Akira KADODA, Kanagawa (JP)

(73) Assignee: FUJIFILM Business Innovation Corp, Tokyo (JP)

(21) Appl. No.: 19/281,024

(22) Filed: Jul. 25, 2025

(30) Foreign Application Priority Data
Mar. 17, 2025 (JP) 2025-042225

(51) Int. Cl. G06F 3/12

(52) U.S. Cl. CPC G06F 3/121; G06F 3/1205; G06F 3/123; G06F 3/1234

(57) ABSTRACT

An image processing apparatus includes a processor configured to: record error information and an error resolution method in association with each other, the error information being related to an error having occurred in a print process performed on print data by the image processing apparatus, the print data being generated by an information processing terminal, the error resolution method describing how to resolve the error in the information processing terminal; and, in response to occurrence of an error in the print process, provide, to the information processing terminal, the error resolution method corresponding to the error information for the error.

### CROSS-REFERENCE TO RELATED APPLICATIONS

This application is based on and claims priority under 35 USC 119 from Japanese Patent Application No. 2025-042225 filed Mar. 17, 2025.

### BACKGROUND

### (i) Technical Field

The present disclosure relates to an image processing apparatus, an information processing terminal, an image processing system, and a non-transitory computer readable medium.

### (ii) Related Art

There is a technique in which, when an error occurs in a print process by an image processing apparatus on print data generated by using a terminal operated by a user, a restoration program for resolving the error is output to the image processing apparatus (for example, Japanese Unexamined Patent Application Publication No. 2003-296082).

However, when the reason of an error in a print process is neither hardware failure of an image processing apparatus nor a fault of settings on the image processing apparatus side, the error fails to be identified on the image processing apparatus side. Thus, the error resolution information which is output may be ambiguous, resulting in the state in which the error resolution takes time.

### SUMMARY

Aspects of non-limiting embodiments of the present disclosure relate to a reduction of an error resolution time for an error in a print process which is not caused by an image processing apparatus, compared with the case of outputting only error resolution information made under the assumption that an error in a print process is caused by an image processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising a processor configured to: record error information and an error resolution method in association with each other, the error information being related to an error having occurred in a print process performed on print data by the image processing apparatus, the print data being generated by an information processing terminal, the error resolution method describing how to resolve the error in the information processing terminal; and, in response to occurrence of an error in the print process, provide, to the information processing terminal, the error resolution method corresponding to the error information for the error.

### BRIEF DESCRIPTION OF THE DRAWINGS

Exemplary embodiment of the present disclosure will be described in detail based on the following figures, wherein:

FIG. 1 is a diagram illustrating an exemplary overall configuration of an image processing system to which the present exemplary embodiment is applied;

FIG. 2 is a diagram illustrating an exemplary hardware configuration of an image processing apparatus to which the present exemplary embodiment is applied;

FIG. 3 is a diagram illustrating an exemplary hardware configuration of a user terminal which is an exemplary information processing terminal to which the present exemplary embodiment is applied;

FIG. 4 is a diagram illustrating an exemplary functional configuration of a controller of an image processing apparatus;

FIG. 5 is a diagram illustrating an exemplary functional configuration of a controller of a user terminal;

FIG. 6 is a flowchart illustrating an exemplary process flow of an image processing apparatus;

FIG. 7 is a flowchart illustrating an exemplary process flow of a user terminal;

FIG. 8 is a diagram illustrating a concrete example of the case in which an error resolution method for the same error is identified;

FIG. 9 is a diagram illustrating a concrete example of the case in which an error resolution method for the same error fails to be identified;

FIG. 10 is a diagram illustrating a concrete example of the case in which newly added information is present when a newly-added-information confirmation is transmitted;

FIG. 11 is a diagram illustrating a concrete example of a process performed when newly added information is not present;

FIGS. 12A and 12B are diagrams illustrating a concrete example of the case in which success information is provided;

FIG. 13 is a diagram illustrating a concrete example of information recorded in association with print data;

FIGS. 14A and 14B are diagrams illustrating concrete examples of screens displayed on a user terminal when measures are taken according to an error resolution method which may be applied before execution of a print process; and

FIGS. 15A and 15B are diagrams illustrating concrete examples of screens displayed on a user terminal when measures are taken according to an error resolution method which may not be applied before execution of a print process.

### DETAILED DESCRIPTION

Referring to the attached drawings, an exemplary embodiment of the present disclosure will be described in detail below.

### Configuration of Image Processing System 1

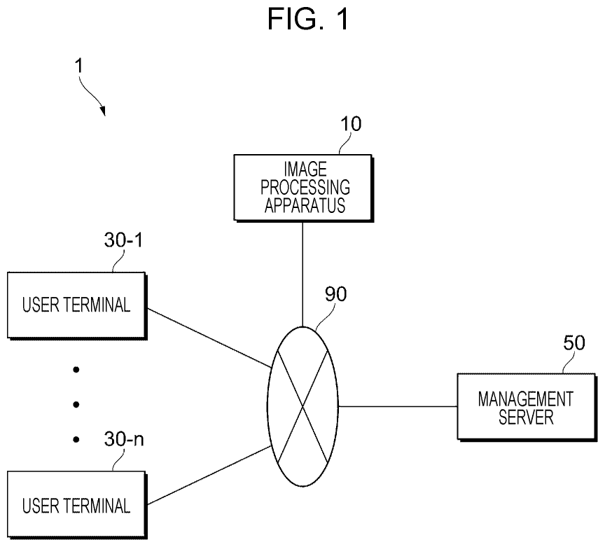

FIG. 1 is a diagram illustrating an exemplary overall configuration of an image processing system 1 to which the present exemplary embodiment is applied.

The image processing system 1 achieves a reduction of an error resolution time when an error in a print process is not caused by an image processing apparatus 10. The image processing system 1 has a configuration in which the image processing apparatus 10, user terminals 30-1 to 30-n (n is an integer greater than or equal to one), and a management server 50 are connected to one another over a network 90. Examples of the network 90 include a local area network (LAN) and the Internet. Hereinafter, when the user terminals 30-1 to 30-n are not necessarily described individually, these are collectively called user terminals 30.

### Image Processing Apparatus 10

The image processing apparatus 10 performs various processes in accordance with input operations of a user who uses the image processing system 1. For example, the image processing apparatus 10 is capable of performing a print process of forming, for output, an image on a sheet or the like as a recording medium, a copy process of copying, for output, a document image onto a sheet or the like, a reading process of reading an image formed on a sheet or the like, and a process of transmitting a document by facsimile. The image processing apparatus 10 may be, for example, a multifunction device of a so-called electrophotographic system which forms a toner image on a print surface of a sheet, or a printer of a so-called inkjet system which ejects ink on a print surface of a sheet.

The image processing apparatus 10 is capable of displaying a user interface and obtaining, for execution of various processes, input information which is input on the user interface. The image processing apparatus 10 is capable of obtaining, for execution of various processes, various types of information transmitted from the user terminals 30, which are connected to the image processing apparatus 10 over the network 90, and the outside. For example, the image processing apparatus 10 obtains input information which is input on the user interface displayed on the user terminals 30. The image processing apparatus 10 is capable of transmitting various information to the user terminals 30 and the outside.

For example, the image processing apparatus 10 records information (hereinafter called “error information”) about an error, which has occurred in a print process on print data generated by a user terminal 30 which is an information processing terminal, in association with an error resolution method for the error which has been applied in the user terminal 30. The error information includes information, such as the number for uniquely identifying the error (for example, the error number described below), description about the error, print data, and the execution date and time of the print process. When an error occurs in a print process, the image processing apparatus 10 provides, to the user terminal 30, an error resolution method corresponding to error information for the error.

Description of an error included in error information is not particularly limited, and the error may occur, for example, due to a mismatch in setting between the image processing apparatus 10 and a user terminal 30. The expression, “a mismatch in setting”, refers, for example, to setting of print parameters. In this case, the expression, “a mismatch in setting of print parameters”, refers, for example, to a difference in setting of print parameters between before and after error resolution. Print parameters include, for example, information, such as sheet size, color/monochrome, the number of copies, single-sided/double-sided, and scale-up/scale-down.

In the present exemplary embodiment, a mismatch in setting of print parameters between the image processing apparatus 10 and a user terminal 30 is a mismatch occurring in the case where an error occurs because the settings of the image processing apparatus 10 are correct and those of the user terminal 30 are not correct, and where the error disappears after modification of settings on the user terminal 30 side. Specifically, for example, a mismatch occurs when the image processing apparatus 10 has a new version and a user terminal 30 has an old version. In this case, the “version” refers, for example, to the version of a driver, the version of application software, or the version of an operating system.

An error resolution method provided from the image processing apparatus 10 to a user terminal 30 may be identified, for example, on the basis of a mismatch in setting of print parameters between before and after error resolution in a user terminal 30 which has succeeded in the error resolution.

The image processing apparatus 10 records error information for an error, which has occurred in a print process on print data generated by the user terminal 30-1, in association with an error resolution method. After that, the image processing apparatus 10 is capable of performing the following processes. That is, when an error occurs in a print process of print data generated by the user terminal 30-2 which is different from the user terminal 30-1, if the image processing apparatus 10 has recorded an error resolution method corresponding to the error, the image processing apparatus 10 provides the error resolution method to the user terminal 30-2. That is, the image processing apparatus 10 allows error resolution methods to be shared among the user terminals 30.

When an error occurs in a print process on print data generated by the user terminal 30-1, if an error resolution method corresponding to the error has not been recorded (fails to be identified), the image processing apparatus 10 provides error information for the error to the user terminal 30-1. When the user terminal 30-1 succeeds in resolving the error, the image processing apparatus 10 records the error resolution method, which is identified from the mismatch in setting of print parameters between before and after the error resolution in the user terminal 30-1, in association with the error information provided to the user terminal 30-1.

In response to reception of the user terminal 30-1's request (hereinafter may be called “newly-added-information confirmation”) to provide methods for resolving errors (hereinafter may be called “newly-added error-resolution methods”) which have not been provided, information about errors which have not been confirmed by the user, information about newly-added errors which have occurred, and the like, the image processing apparatus 10 is capable of performing, for example, the following processes. That is, among error resolution methods associated with error information, the image processing apparatus 10 is capable of providing, to the user terminal 30-1, combinations between error resolution methods, which are regarded for the user terminal 30-1 as being newly added, and their associated pieces of error information.

When there are no error resolution methods which have not been provided to the user terminal 30-1, the image processing apparatus 10 is capable of performing, for example, the following processes. That is, the image processing apparatus 10 records print data, on which a print process has succeeded, in association with the setting of print parameters of the user terminal 30-1 (hereinafter may be called “success information”) which were used when the print process succeeded.

The success information may include information, such as print data, the execution date and time of a print process, the driver type, the user name, application software, and operating system (OS), in addition to the settings of print parameters. In addition, in response to a request from the user terminal 30-2 which is different from the user terminal 30-1, the image processing apparatus 10 provides, to the user terminal 30-2, print data on which a print process has succeeded, and the settings of print parameters of the user terminal 30-1 when the print process has succeeded.

When there are no error resolution methods which have not been provided to the user terminal 30-1, if an error occurs in a print process on print data generated by the user terminal 30-2 which is different from the user terminal 30-1, the image processing apparatus 10 is capable of performing the following processes. That is, the image processing apparatus 10 records the user terminal 30-2′s settings of print parameters at occurrence of the error, in association with print data which is among pieces of print data on which print processes have succeeded and which is similar to the print data for which the error has occurred. In the present exemplary embodiment, the expression, “similar”, indicates that an object belongs to a range predetermined as a range in which similarity is recognized. The image processing apparatus 10 provides, to the user terminal 30-2, the recorded print data and the settings of print parameters with which a print process has succeeded and which corresponds to the print data. The configuration and the processes of the image processing apparatus 10 will be described in detail below.

### User Terminals 30

The user terminals 30 are information processing terminals, such as smartphones, tablet terminals, and personal computers, which are operated by users using the image processing system 1. In the user terminals 30, application software and printer driver programs, which display a user interface for enabling print data to be generated and enabling an instruction to perform a print process to be provided, are installed.

The user terminals 30 are capable of obtaining, for execution of various processes, various types of information transmitted from the image processing apparatus 10, the management server 50, and the outside. The user terminals 30 are capable of transmitting various types of information to the image processing apparatus 10, the management server 50, and the outside.

For example, the user terminals 30 generate print data on the basis of user operations, for transmission to the image processing apparatus 10. The user terminals 30 transmit, to the image processing apparatus 10, instructions to perform print processes. The user terminals 30 are capable of requesting, from the image processing apparatus 10, provision of methods for resolving errors which have occurred in print processes on print data transmitted to the image processing apparatus 10.

After transmission of a newly-added-information confirmation from a user terminal 30 to the image processing apparatus 10, when a newly-added error-resolution method is provided as newly added information from the image processing apparatus 10, the user terminal 30 performs the following processes. That is, the user terminal 30 classifies the newly-added error-resolution method, which is provided as newly added information, to a method which may be applied before the image processing apparatus 10's execution of a print process, or a method which may not be applied before a print process. The user terminal 30 takes measures according to the error resolution method which may be applied before the image processing apparatus 10's execution of a print process, and pends measures taken according to the error resolution method which may not be applied before the image processing apparatus 10's execution of a print process. The configuration and the processes of a user terminal 30 will be described in detail below.

### Management Server 50

The management server 50 is an information processing apparatus functioning as a server which manages the entire image processing system 1. The management server 50 is capable of transmitting, for execution of various processes, various types of information to the image processing apparatus 10, the user terminals 30, and the outside. The management server 50 is capable of obtaining, for execution of various processes, various types of information transmitted from the image processing apparatus 10, the user terminals 30, and the like.

For example, the management server 50 may have some or all of the functions of the image processing apparatus 10. Among the functions of the image processing apparatus 10, for example, the management server 50 may have a function of recording error information in association with an error resolution method. In this case, the user terminals 30 are capable of using a combination of error information and an error resolution method, which is provided from the management server 50, in error resolution. As a result, compared with the case in which the image processing apparatus 10 records combinations between error information and error resolution methods, the processing burden of the image processing apparatus 10 is reduced. The combinations between error information and error resolution methods may be recorded in either one or both of the image processing apparatus 10 and the management server 50.

The configuration of the image processing system 1 is exemplary. As long as the image processing system 1, as a whole, has a function of implementing the above-described processes, the image processing system 1 may have any configuration. Therefore, among functions for implementing the above-described processes, some or all may be shared in the image processing system 1, or may be performed in cooperation. For example, some or all of the functions of the image processing apparatus 10 included in the image processing system 1 may be performed as functions of a different information processing apparatus (for example, the management server 50) or a different information processing terminal (for example, a user terminal 30). Some or all of the functions of a different information processing apparatus or a different information processing terminal may be performed as functions of the image processing apparatus 10. Further, some or all of the functions of the image processing apparatus 10 and other apparatuses included in the image processing system 1 may be transferred to another server or the like (not illustrated). Thus, functions as the entire image processing system 1 may be promoted. In addition, processes may be complemented to one another.

### Hardware Configuration

Hardware Configuration of Image Processing Apparatus 10

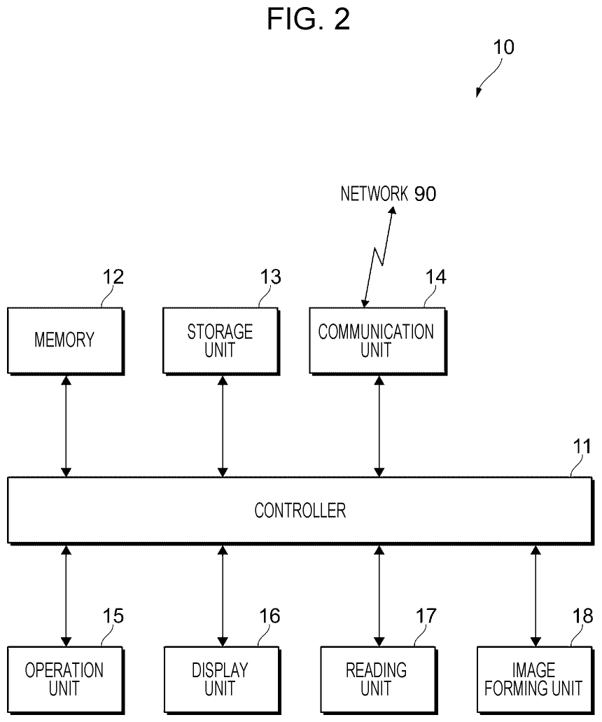

FIG. 2 is a diagram illustrating an exemplary hardware configuration of the image processing apparatus 10 to which the present exemplary embodiment is applied.

The image processing apparatus 10 includes a controller 11, a memory 12, a storage unit 13, a communication unit 14, an operation unit 15, a display unit 16, a reading unit 17, and an image forming unit 18. These units are connected to one another, for example, through a data bus, an address bus, or a peripheral component interconnect (PCI) bus.

The controller 11 is a processor which controls functions of the image processing apparatus 10 through execution of various types of software, such as basic software (OS) and application software. In the present exemplary embodiment, the processes are performed by any computer. The computer may perform the processes by using a processor serving as hardware, a program serving as software, or combination of these. In this case, the processor is configured to perform the processes in the exemplary embodiment in cooperation with the program and may function as a unit or a means in the exemplary embodiment. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The memory 12, which is a storage area for storage of various types of software and data or the like used in execution of the software, is used as a work area in computation. The memory 12 is formed, for example, of a random access memory (RAM).

The storage unit 13 is a storage area for storage of input data for various types of software, output data from various types of software, and the like. The storage unit 13 is formed, for example, of a hard disk drive (HDD) or a solid state drive (SSD), and a semiconductor memory which are used in storage of programs, various types of setting data, and the like. The storage unit 13 includes a database storing various types of information.

The communication unit 14 receives/transmits data from/to the user terminals 30 and the outside over the network 90. The operation unit 15, which is formed, for example, of a keyboard, a mouse, mechanical buttons, and switches, receives input operations.

The operation unit 15 includes a touch sensor forming a touch panel integrally with the display unit 16.

The display unit 16, which is formed, for example, of a liquid-crystal display or an organic light-emitting diode (OLED) display used in display of information, displays image data, text data, and the like. The display unit 16 displays a user interface or the like.

The reading unit 17 reads an image recorded on a medium such as a sheet. The reading unit 17 may be formed, for example, of a charge coupled device (CCD) scanner which reduces, through a lens, reflected light for light emitted onto a document from a light source and which receives the reduced light by CCDs. The reading unit 17 may be formed, for example, of a contact image sensor (CIS) scanner which receives, by a CIS, reflected light for light emitted sequentially onto a document from a light-emitting diode (LED) light source.

The image forming unit 18 forms an image, which is to be printed, on a print surface of a sheet serving as a recording medium, for example, by using an electrophotographic system or an inkjet system.

### Hardware Configuration of User Terminal 30

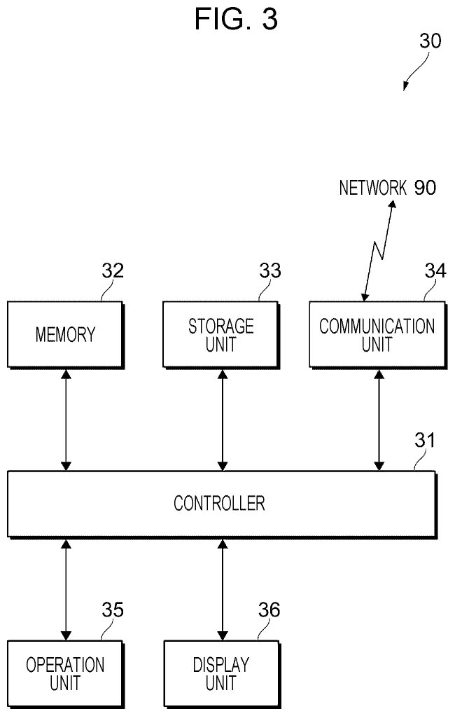

FIG. 3 is a diagram illustrating an exemplary hardware configuration of a user terminal 30 which is an exemplary information processing terminal to which the present exemplary embodiment is applied.

The user terminal 30 includes a controller 31, a memory 32, a storage unit 33, a communication unit 34, an operation unit 35, and a display unit 36 which correspond to the controller 11, the memory 12, the storage unit 13, the communication unit 14, the operation unit 15, and the display unit 16, respectively, in FIG. 2. These units are connected to one another through a data bus, an address bus, a PCI bus, or the like.

### Hardware Configuration of Management Server 50

The management server 50 includes a controller, a memory, a storage unit, a communication unit, an operation unit, and a display unit which correspond to the controller 11, the memory 12, the storage unit 13, the communication unit 14, the operation unit 15, and the display unit 16, respectively, in FIG. 2. These units are connected to one another through a data bus, an address bus, a PCI bus, or the like.

### Functional Configuration

Functional Configuration of Image Processing Apparatus 10

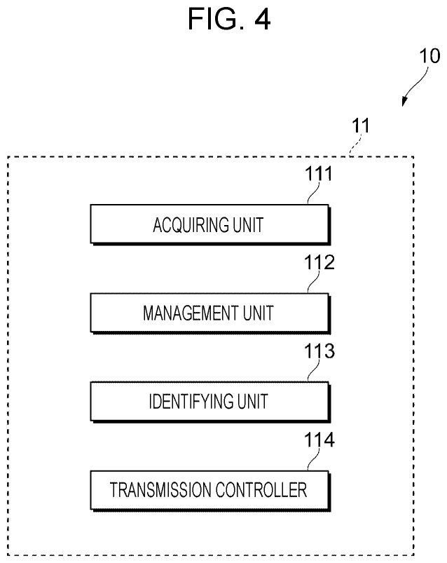

FIG. 4 is a diagram illustrating an exemplary functional configuration of the controller 11 of the image processing apparatus 10.

The controller 11 of the image processing apparatus 10 functions as an acquiring unit 111, a management unit 112, an identifying unit 113, and a transmission controller 114.

The acquiring unit 111 acquires various types of information. For example, the acquiring unit 111 acquires a request to provide newly-added error-resolution methods, as a newly-added-information confirmation from a user terminal 30. The acquiring unit 111 acquires setting information of print parameters of a user terminal 30. The acquiring unit 111 acquires a user terminal 30's request to provide setting information of print parameters. The acquiring unit 111 acquires an instruction to perform a print process. The instruction is transmitted with print data from a user terminal 30.

The management unit 112 stores, for management, various types of information in the database in the storage unit 13 (see FIG. 2). For example, the management unit 112 stores, for management, the results of print processes, which were performed by its own image processing apparatus, on print data, which is generated by the user terminals 30, in the database as processing result information. The processing result information includes information, such as print data, setting information of print parameters used when print processes were performed, information indicating that the print processes succeeded, error information for errors which occurred in the print processes, and error resolution methods which were applied in the user terminals 30. Among the processing result information, the management unit 112 manages error information and error resolution methods in association with each other.

The identifying unit 113 identifies an error resolution method that is to be provided to a user terminal 30. For example, the identifying unit 113 identifies an error resolution method, which is to be provided to a user terminal 30, on the basis of a mismatch caused by a difference in print parameters between before and after error resolution successfully performed by a user terminal 30.

The transmission controller 114 exerts control for transmitting various types of information to the user terminals 30, the management server 50, and the outside through the communication unit 14 (see FIG. 2). For example, the transmission controller 114 exerts control for transmitting, to a user terminal 30, an error resolution method for an error which has occurred in a print process. The transmission controller 114 exerts control for transmitting error information to a user terminal 30. When a print process succeeds, the transmission controller 114 exerts control for transmitting, to the user terminal 30, information about the success as a success notification.

### Functional Configuration of User Terminal 30

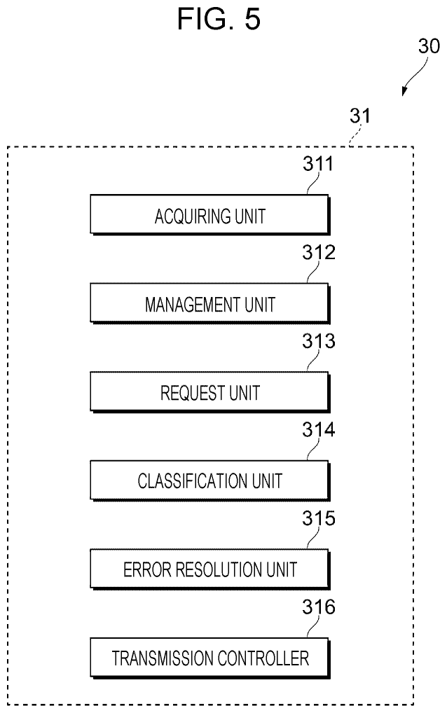

FIG. 5 is a diagram illustrating an exemplary functional configuration of the controller 31 of a user terminal 30.

The controller 31 of the user terminal 30 functions as an acquiring unit 311, a management unit 312, a request unit 313, a classification unit 314, an error resolution unit 315, and a transmission controller 316.

The acquiring unit 311 acquires various types of information. For example, the acquiring unit 311 acquires an error resolution method transmitted from the image processing apparatus 10. The acquiring unit 311 acquires error information transmitted from the image processing apparatus 10. The acquiring unit 311 acquires a success notification transmitted from the image processing apparatus 10.

The management unit 312 stores, for management, information in the storage unit 33 (see FIG. 3). For example, the management unit 312 stores, for management, an error resolution method acquired by the acquiring unit 311. The management unit 312 stores, for management, error information, which is acquired by the acquiring unit 311, in the storage unit 33.

The request unit 313 requests, from the image processing apparatus 10, provision of newly-added error-resolution methods, as a newly-added-information confirmation. The request unit 313 requests, from the image processing apparatus 10, provision of error information

The classification unit 314 classifies an error resolution method, which is provided from the image processing apparatus 10, to a method which may be applied before the image processing apparatus 10's execution of a print process, or a method which may not be applied before the print process. In this case, examples of a method which may be applied before a print process include common settings of a driver. Examples of a method which may not be applied before a print process include print settings of a driver.

The error resolution unit 315 performs error resolution according to an error resolution method managed by the management unit 312. The error resolution unit 315 performs error resolution on the basis of error information managed by the management unit 312.

The transmission controller 316 exerts control for transmitting various types of information to the image processing apparatus 10, the management server 50, and the outside through the communication unit 34 (see FIG. 3). For example, the transmission controller 316 exerts control for transmitting generated print data to the image processing apparatus 10. The transmission controller 316 exerts control for transmitting, to the image processing apparatus 10, an instruction to perform a print process. The transmission controller 316 exerts control for transmitting, to the image processing apparatus 10, a request for provision of newly-added error-resolution methods.

### Process Flow

Process Flow of Image Processing Apparatus 10

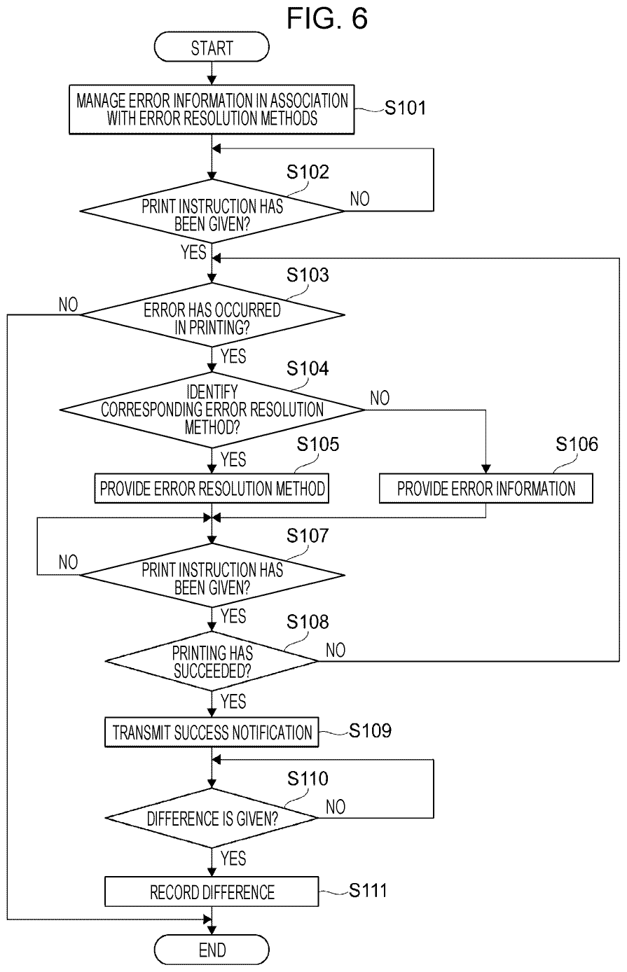

FIG. 6 is a flowchart illustrating an exemplary process flow of the image processing apparatus 10.

The image processing apparatus 10 manages error information and error resolution methods in association with each other (step 101). If a print instruction has been given (YES in step 102), the image processing apparatus 10 proceeds to the determination process in step 103. In contrast, if a print instruction has not been given (NO in step 102), the image processing apparatus 10 repeatedly performs the determination process in step 102.

If an error has occurred in printing in a print process on print data (YES in step 103), the image processing apparatus 10 proceeds to the determination process in step 104. In contrast, if an error has not occurred in printing (NO in step 103), the image processing apparatus 10 ends the process (END).

If an error resolution method corresponding to the error having occurred in printing is identified (YES in step 104), the image processing apparatus 10 provides the error resolution method to the user terminal 30 (step 105), and proceeds to the determination process in step 107. In contrast, if an error resolution method corresponding to the error having occurred in printing fails to be identified (NO in step 104), the image processing apparatus 10 provides error information for the error to the user terminal 30 (step 106), and proceeds to the determination process in step 107.

If a print instruction has been given (YES in step 107), the image processing apparatus 10 proceeds to the determination process in step 108. In contrast, if a print instruction has not been given (NO in step 107), the image processing apparatus 10 repeatedly performs the determination process in step 107. If the printing has succeeded (YES in step 108), the image processing apparatus 10 transmits a success notification to the user terminal 30 (step 109), and proceeds to the determination process in step 110. In contrast, if the printing has not succeeded (NO in step 108), the image processing apparatus 10 returns to the determination process in step 103.

If a difference in setting of print parameters between before and after the error resolution is given as a mismatch of different settings of print parameters (YES in step 110), the image processing apparatus 10 records the difference (step 111). Specifically, the image processing apparatus 10 stores, for management in the database, the difference in setting of print parameters between before and after the error resolution, in association with error information for the error. Thus, the image processing apparatus 10 ends the process (END). In contrast, if a difference in setting of print parameters between before and after the error resolution has not been given (YES in step 110), the image processing apparatus 10 repeatedly performs the determination process in step 110.

### Process Flow of User Terminal 30

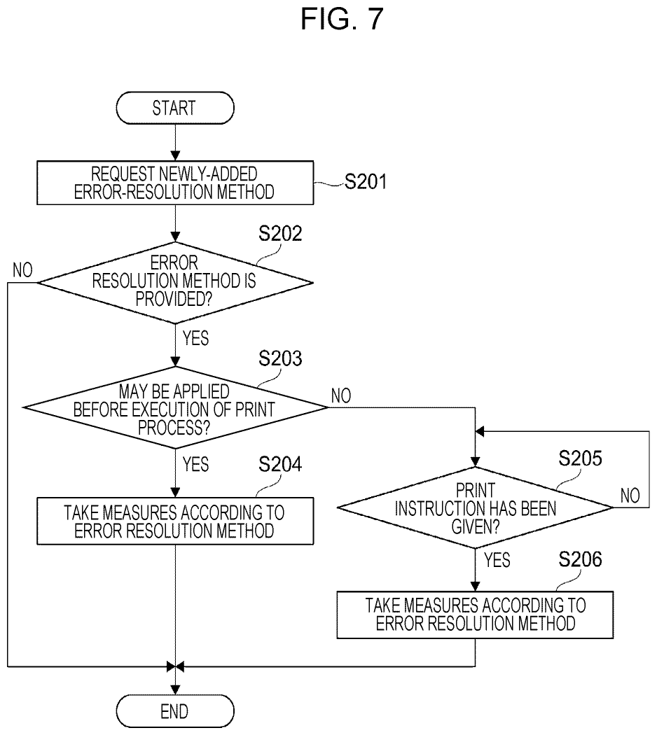

FIG. 7 is a flowchart illustrating an exemplary process flow of a user terminal 30.

The user terminal 30 requests a newly-added error-resolution method, as a newly-added-information confirmation (step 201). If a newly-added error-resolution method is provided from the image processing apparatus 10 since the error-resolution method is identified as being newly added (YES in step 202), the user terminal 30 proceeds to the determination process in step 203. In contrast, if a newly-added error-resolution method has not been provided since there are no newly-added error-resolution methods (NO in step 202), the user terminal 30 ends the process (END).

If the error resolution method provided in step 202 may be applied before execution of a print process (YES in step 203), the user terminal 30 takes measures according to the error resolution method (step 204), and ends the process (END). In contrast, if the error resolution method provided in step 202 may not be applied before execution of a print process (NO in step 203), the user terminal 30 proceeds to the determination process in step 205.

If a print instruction has been given (YES in step 205), the user terminal 30 takes measures according to the error resolution method provided in step 202 (step 206), and ends the process (END). In contrast, if a print instruction has not been given (NO in step 205), the user terminal 30 repeatedly performs the determination process in step 205.

### Concrete Examples

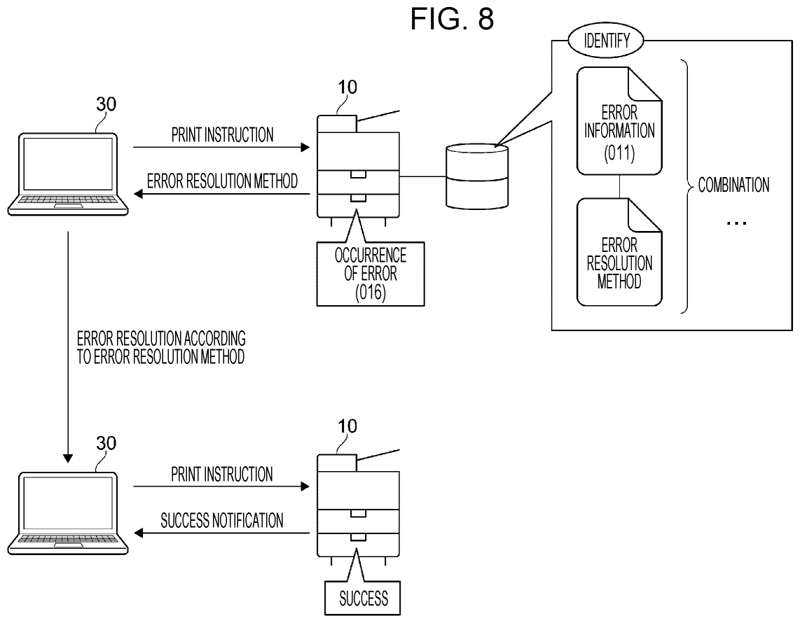

FIG. 8 is a diagram illustrating a concrete example of the case in which an error resolution method for the same error is identified.

As illustrated in FIG. 8, an error has occurred in the image processing apparatus 10's print process initiated by a print instruction from a user terminal 30. In this case, the image processing apparatus 10 checks if, in the recorded combinations between error information and error resolution methods, there is information for the same error as that having occurred.

When there is information for the same error as that having occurred, the image processing apparatus 10 provides, to the user terminal 30, the error resolution method associated with error information for the error. In the example in FIG. 8, a combination of error information, which has an error number (011) common to that of the error having occurred, and an error resolution method is identified. Thus, the error resolution method is provided to the user terminal 30.

The user terminal 30, to which the image processing apparatus 10 has provided the error resolution method, performs error resolution according to the error resolution method, and transmits again a print instruction to the image processing apparatus 10. The image processing apparatus 10, which has received the print instruction, starts a print process again. When the print process succeeds, the image processing apparatus 10 transmits a success notification to the user terminal 30.

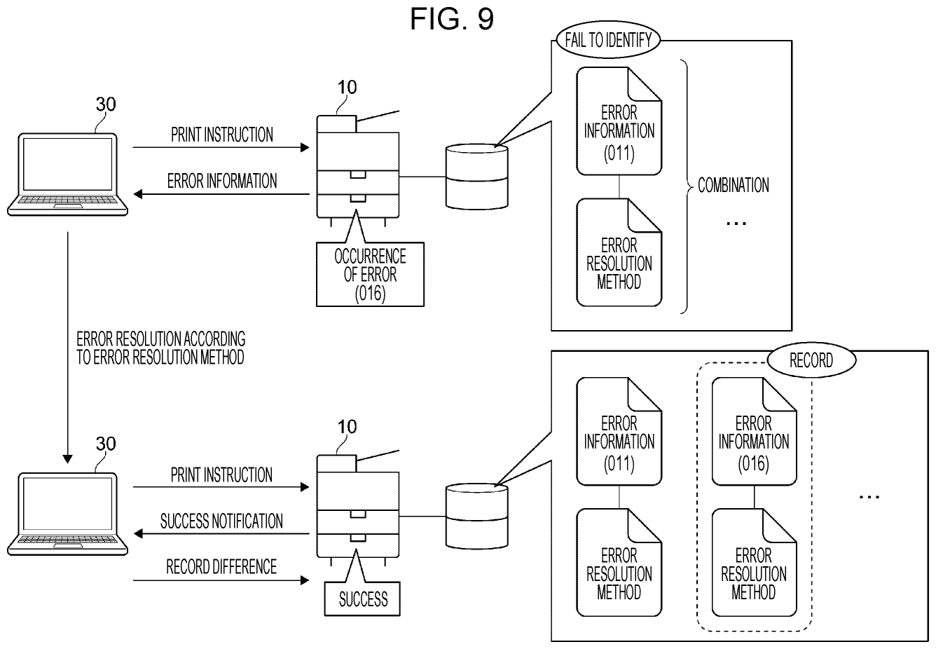

FIG. 9 is a diagram illustrating a concrete example of the case in which an error resolution method for the same error fails to be identified.

As in the example in FIG. 9, among combinations between error information and error resolution methods, which are recorded in the image processing apparatus 10, in some cases, there is no combination for an error having occurred. In this case, error information for the error is provided to the user terminal 30. In the example in FIG. 9, since a combination of an error resolution method and error information, which has an error number (016) common to the error having occurred, fails to be identified, error information for the error having occurred is provided to the user terminal 30.

The user terminal 30, which has received provision of the error information from the image processing apparatus 10, performs error resolution in accordance with the error information, and transmits a print instruction again to the image processing apparatus 10. The image processing apparatus 10, which has received the print instruction, starts a print process again. When the print process succeeds, the image processing apparatus 10 transmits a success notification to the user terminal 30. After that, a difference in setting of print parameters between before and after the error resolution is provided as a mismatch in setting of print parameters, from the user terminal 30 to the image processing apparatus 10. The image processing apparatus 10 records the provided difference in association with the error information (error number: 016) for the error having occurred. Thus, a new combination of the error information and the error resolution method is added.

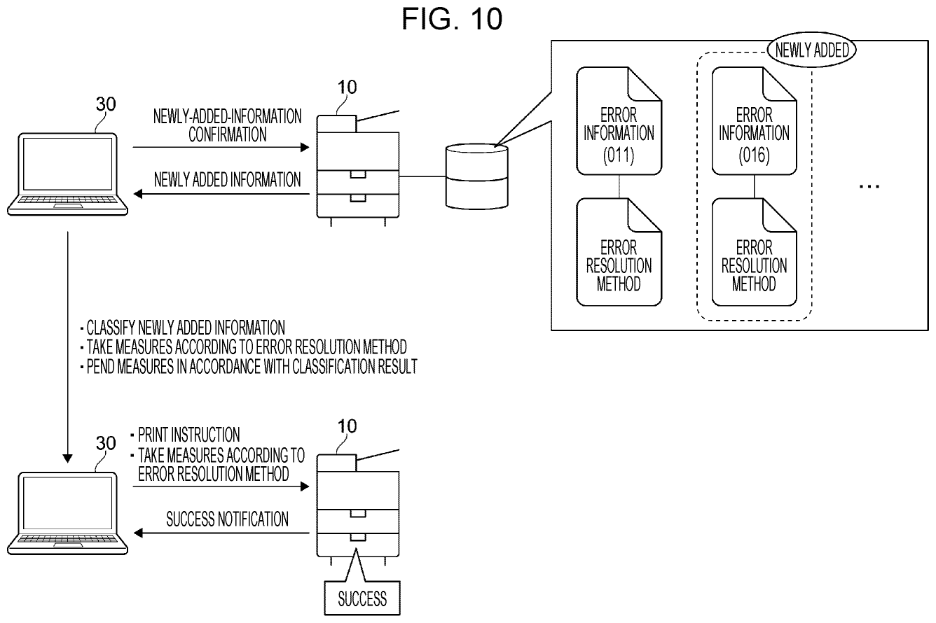

FIG. 10 is a diagram illustrating a concrete example of the case in which newly added information is present when a newly-added-information confirmation is transmitted.

As illustrated in FIG. 10, when a user terminal 30 requests a newly-added error-resolution method from the image processing apparatus 10 as a newly-added-information confirmation, the image processing apparatus 10 checks if a newly-added error-resolution method has been recorded. When a newly-added error-resolution method has been recorded, the image processing apparatus 10 provides the newly-added error-resolution method to the user terminal 30 as newly added information. In the example in FIG. 10, a combination of error information (error number: 016) and an error resolution method, which is identified as a newly-added error-resolution method, is provided to the user terminal 30 as newly added information.

The user terminal 30, which has received provision of the newly added information from the image processing apparatus 10, classifies the newly added information to information which may be applied before the image processing apparatus 10's execution of a print process, or information which may not be applied before the image processing apparatus 10's execution of a print process. The user terminal 30 takes measures according to the error resolution method, or pends measures taken according to the error resolution method in accordance with the classification result. Specifically, the user terminal 30 takes measures according to the error resolution method which may be applied before the image processing apparatus 10's execution of a print process, or pends measures taken according to the error resolution method which may not be applied before the image processing apparatus 10's execution of a print process.

After that, the user terminal 30 transmits a print instruction to the image processing apparatus 10. In execution of a print process, the user terminal 30 takes measures according to the error resolution method which has been pended since it is classified to a method which may not be applied before execution of a print process. The image processing apparatus 10, which has received the print instruction, starts a print process again. When the print process succeeds, the image processing apparatus 10 transmits a success notification to the image processing apparatus 10.

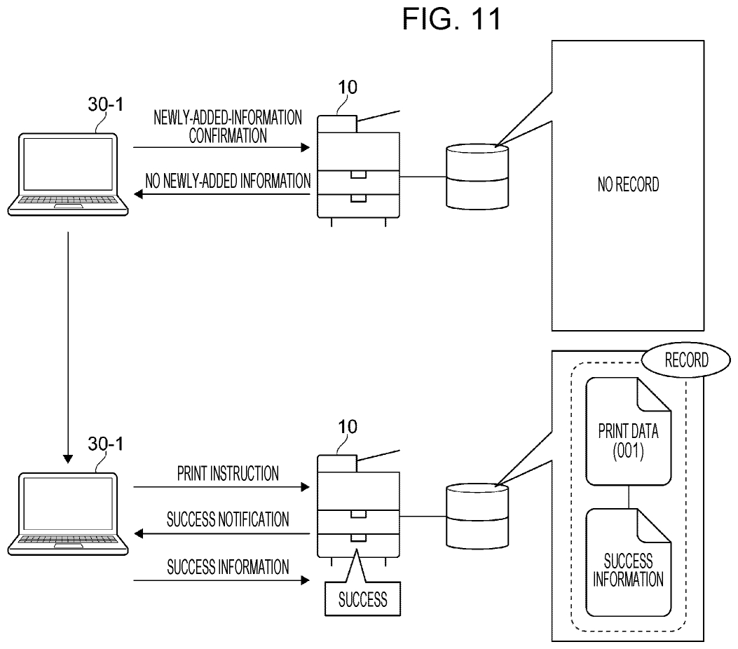

FIG. 11 is a diagram illustrating a concrete example of a process performed when there is no newly added information.

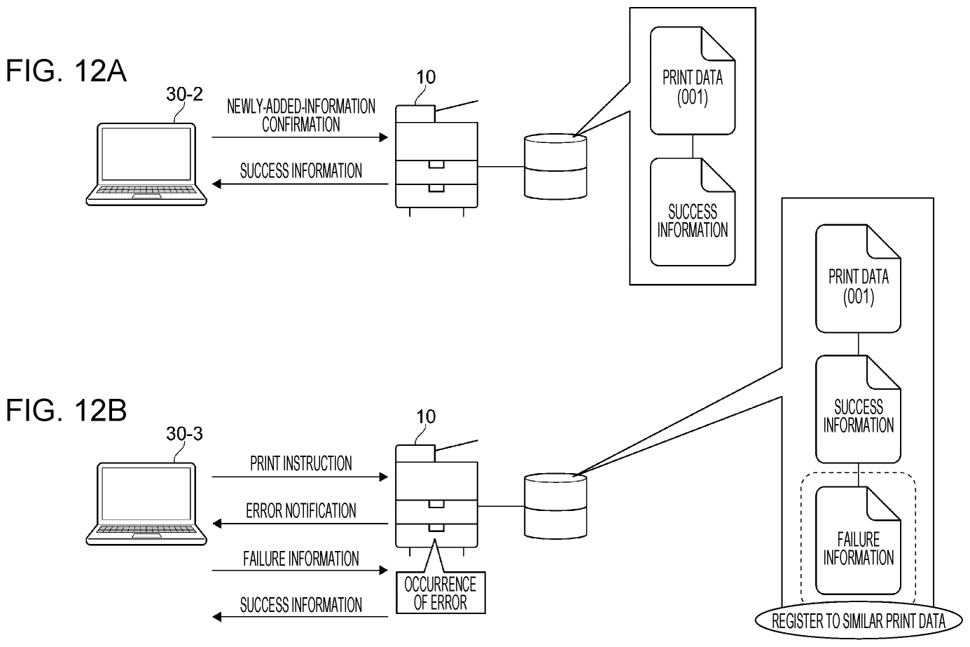

FIGS. 12A and 12B are diagrams illustrating concrete examples of the case in which success information is provided.

FIGS. 11, 12A, and 12B illustrate processes connected chronologically in this order.

As illustrated in FIG. 11, in response to a newly-added-information confirmation from the user terminal 30-1, the image processing apparatus 10 checks if a newly-added error-resolution method has been recorded. When a newly-added error-resolution method has not been recorded, the image processing apparatus 10 performs the following processes. That is, the image processing apparatus 10 responds to the user terminal 30-1 that no newly added information is present.

The user terminal 30-1, which has received, from the image processing apparatus 10, the respond that no newly added information is present, transmits a print instruction to the image processing apparatus 10. The image processing apparatus 10, which has received the print instruction, starts a print process. When the print process succeeds, the image processing apparatus 10 transmits a success notification to the user terminal 30-1. The user terminal 30-1, which has received the success notification, provides, to the image processing apparatus 10, the settings of print parameters used when the print process succeeded, as success information. The image processing apparatus 10, which has received the success information, records print data, on which the print process succeeded, in association with the success information. In the example in FIG. 11, print data (print data number: 001), on which the print process succeeded, and the success information are recorded in association with each other.

As illustrated in FIG. 12A, when, in response to a newly-added-information confirmation from the user terminal 30-2, it is found that a newly-added error-resolution method has not been recorded but the success information provided by the user terminal 30-1 has been recorded, the success information is provided to the user terminal 30-2. The user terminal 30-2, which has received provision of the success information, compares their own settings of print parameters with the settings of print parameters which are specified from the success information, and corrects a mismatch in settings or the like.

As illustrated in FIG. 12B, when the user terminal 30-3 transmits a print instruction to the image processing apparatus 10, the image processing apparatus 10, which has received the print instruction, starts a print process. After that, assume that an error occurs in the print process. In this case, the image processing apparatus 10 transmits an error notification to the user terminal 30-3. The user terminal 30-3, which has received the error notification, provides, to the image processing apparatus 10, the settings of print parameters, which were used at that time, as failure information.

The failure information may include, in addition to settings of print parameters, information about print data, the execution date and time of the print process, the driver type, the user name, the application software, the OS, and the like. The image processing apparatus 10, which has received provision of the failure information, records the failure information in association with print data similar to the print data related to the print process in which the error has occurred, among pieces of print data on which print processes succeeded.

In the example in FIG. 12B, print data (print data number: 001) similar to the print data related to the print process in which the error has occurred has been recorded. As illustrated in FIG. 11, the print data (print data number: 001) is recorded in association with success information. Therefore, the image processing apparatus 10 further records the failure information in association with the print data (print data number: 001) associated with success information. Thus, a combination of the print data (print data number: 001), the success information, and the failure information is recorded.

The image processing apparatus 10 provides, to the user terminal 30-3 from which the failure information is provided, the success information associated with the failure information. The user terminal 30-3, which has received provision of the success information, compares their own settings of print parameters with the settings of print parameters which are specified from the success information, and corrects a mismatch in settings or the like.

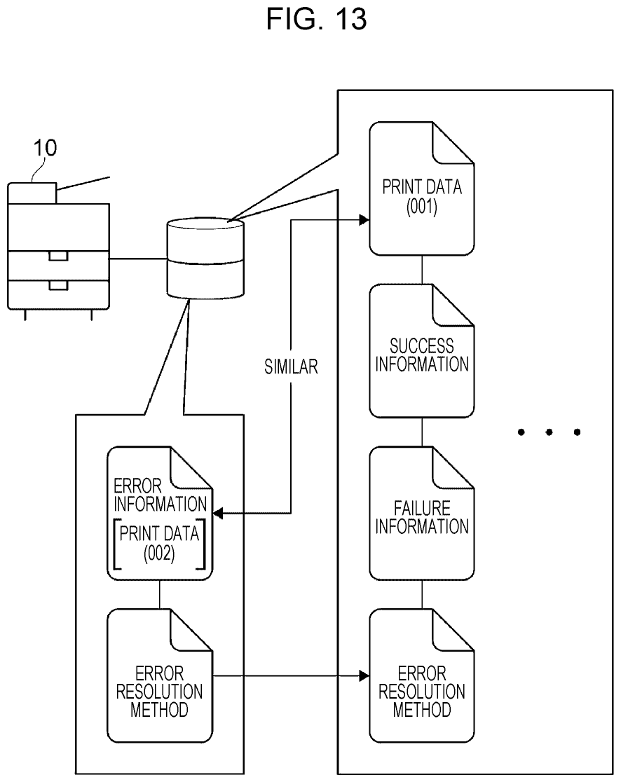

FIG. 13 is a diagram illustrating a concrete example of information recorded in association with print data.

FIG. 12B illustrates the example in which success information and failure information are recorded in association with print data. Information which may be associated with print data is not limited to this. An error resolution method may be further associated with print data. FIG. 13 illustrates an example in which success information, failure information, and an error resolution method are recorded in association with the print data (print data number: 001). In this case, an error resolution method associated with the print data (print data number: 001) is stored in association with error information for an error related to different print data (print data number: 002) which is similar to the print data (print data number: 001).

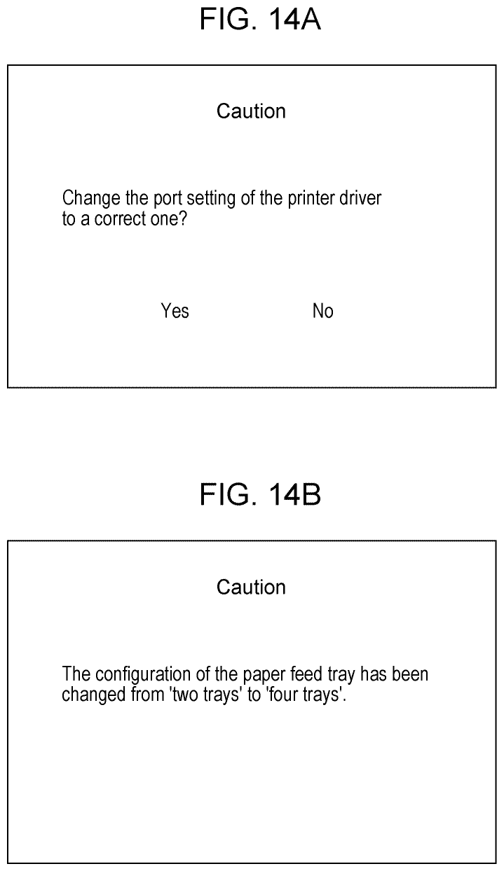

FIGS. 14A and 14B are diagrams illustrating concrete examples of screens displayed on a user terminal 30 when measures are taken according to an error resolution method which may be applied before execution of a print process.

As described above, the user terminal 30 classifies a newly-added error-resolution method, which is provided as newly added information, to a method which may be applied before the image processing apparatus 10's execution of a print process or a method which may not be applied before the image processing apparatus 10's execution of a print process, and takes measures according to an error resolution method which may be applied before a print process. Such measures are taken, for example, just after startup of a user terminal 30, at any time point based on a schedule which is set in advance by a user, or at a time when a user performs a manual operation.

When measures such as change of settings of an OS may affect operations of other application software, a screen for asking a user for consent may be displayed on a user terminal 30. FIG. 14A illustrates a concrete example of a screen displayed on the display unit 36 (see FIG. 3) of a user terminal 30 when a setting managed by an OS is to be changed. On the screen illustrated in FIG. 14A, a caption, “Caution”, for calling attention, a message, “Change the port setting of the printer driver to a correct one?” and buttons for selecting “Yes” or “No” are illustrated.

When measures are such that the range of influence of change of settings is limited to a target driver and the image processing apparatus 10, without asking a user for consent, only the result of the change of settings may be displayed on a user terminal 30. FIG. 14B illustrates a concrete example of a screen displayed on a user terminal 30 after change of a setting of the image processing apparatus 10. On the screen illustrated in FIG. 14B, a caption, “Caution”, for calling attention, and a message, “The configuration of the paper feed tray has been changed from ‘two trays’ to ‘four trays’.” are illustrated. Execution of such measures beforehand eliminates an error which may occur in the image processing apparatus 10's execution of a print process.

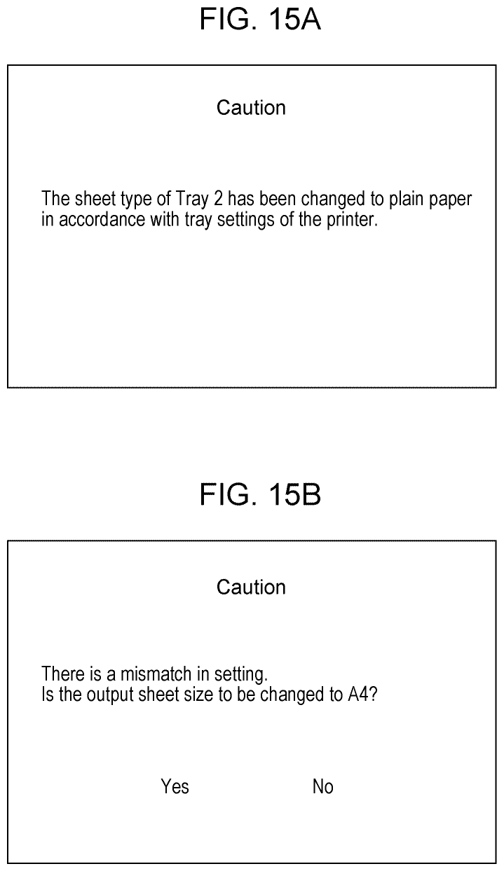

FIGS. 15A and 15B are diagrams illustrating concrete examples of screens displayed on a user terminal 30 when measures are taken according to an error resolution method which may not be applied before execution of a print process.

As described above, a user terminal 30 classifies a newly-added error-resolution method, which is provided as newly added information, to a method which may be applied before the image processing apparatus 10's execution of a print process or a method which may not be applied before execution of a print process, and takes measures according to an error resolution method which may not be applied before execution of a print process. Such measures are taken, for example, at startup of a printer driver.

In the case where an error may occur when the image processing apparatus 10 starts a print process, a screen for warning this may be displayed on a user terminal 30. FIG. 15A illustrates a concrete example of the case in which a message, indicating that the setting of a print parameter has been changed because, when a print process starts, an error may occur, is displayed on the display unit 36 of a user terminal 30. On the screen illustrated in FIG. 15A, a caption, “Caution”, for calling attention, and a message, “The sheet type of Tray 2 has been changed to plain paper in accordance with tray settings of the printer.” are illustrated.

When setting of a print parameter causes an error to occur, a screen for asking a user for consent may be displayed on a user terminal 30. FIG. 15B illustrates a concrete example of a screen displayed on a user terminal 30 when the setting of a print parameter is to be changed to a setting which does not cause an error to occur. On the screen illustrated in FIG. 15B, a caption, “Caution”, for calling attention, a message, “There is a mismatch in setting. Is the output sheet size to be changed to A4?” and buttons for selecting “Yes” or “No” are illustrated. Taking such measures suppresses occurrence of an error in the image processing apparatus 10's execution of a print process.

### Other Exemplary Embodiments

The present exemplary embodiment is described above. However, the present disclosure is not limited to the above-described exemplary embodiment. The effects of the present disclosure are not limited to those described in the exemplary embodiment. For example, each of the overall configuration of the image processing system 1 in FIG. 1, the hardware configuration of the image processing apparatus 10 in FIG. 2, and the hardware configuration of a user terminal 30 in FIG. 3 is merely exemplary to achieve the object of the present disclosure, and is not limited particularly.

The functional configuration of the image processing apparatus 10 in FIG. 4 and the functional configuration of a user terminal 30 in FIG. 5 are merely exemplary, and are not limited particularly. Any configuration may be employed as long as a function which may perform, as a whole, the processes described above is included in the image processing system 1 in FIG. 1. The functional configuration used to implement this function is not limited to the examples in FIGS. 4 and 5. The order of steps of processes of the image processing apparatus 10 which is illustrated in the flowchart in FIG. 6, and the order of steps of the processes of a user terminal 30 which is illustrated in the flowchart in FIG. 7 are merely exemplary, and are not limited particularly. Other than processes performed in a time-series manner according to the order of illustrated steps, processes may be performed, not necessarily in a time series manner, but in parallel or individually. The concrete examples illustrated in FIGS. 8 to 15 are merely exemplary, and are not limited particularly.

In the exemplary embodiment above, a mismatch in setting of print parameters between the image processing apparatus 10 and a user terminal 30 is a mismatch in the case where the settings in the image processing apparatus 10 are correct and the settings in the user terminal 30 are not correct. However, the configuration is not limited to this. A mismatch in setting of print parameters between the image processing apparatus 10 and a user terminal 30 may be a mismatch in the case where the settings in the user terminal 30 are correct and the settings in the image processing apparatus 10 are not correct. Specifically, for example, the version of a user terminal 30 may be new, and the version of the image processing apparatus 10 may be old.

The present disclosure may be applied also to programs and program products.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))
An image processing apparatus comprising:
a processor configured to:
   record error information and an error resolution method in association with each other, the error information being related to an error having occurred in a print process performed on print data by the image processing apparatus, the print data being generated by an information processing terminal, the error resolution method describing how to resolve the error in the information processing terminal; and
in response to occurrence of an error in the print process, provide, to the information processing terminal, the error resolution method corresponding to the error information for the error.
(((2)))
The image processing apparatus according to (((1))),
wherein the error has occurred due to a mismatch in setting between the image processing apparatus and the information processing terminal.
(((3)))
The image processing apparatus according to (((2))),
wherein the mismatch in setting is a mismatch in the case where the setting of the image processing apparatus is correct and where the setting of the information processing terminal is not correct.
(((4)))
The image processing apparatus according to (((3))),
wherein the setting is setting of a print parameter.
(((5)))
The image processing apparatus according to (((3))),
wherein the error resolution method is identified on a basis of the mismatch in setting between before and after resolution of the error in the information processing terminal which has succeeded in the error resolution.
(((6)))
The image processing apparatus according to (((3))),
wherein the processor is configured to:
   in response to occurrence of the error in the print process on print data generated by an information processing terminal different from the information processing terminal, provide, to the different information processing terminal, the error resolution method corresponding to the error information for the error.
(((7)))
The image processing apparatus according to (((3))),
wherein the processor is configured to:
   when the error resolution method corresponding to the error has not been recorded at a time of occurrence of the error, provide, to the information processing terminal, the error information for the error; and
   record the error resolution method and the error information in association with each other, the error resolution method being identified from the mismatch in setting between before and after resolution of the error in the information processing terminal which has succeeded in resolving the error, the error information having been provided to the information processing terminal.
(((8)))
The image processing apparatus according to (((3))),
wherein the processor is configured to:
   in response to a request from the information processing terminal, provide, to the information processing terminal, the error resolution method and the error information, the error resolution method being among the recorded error resolution methods and having not been provided to the information processing terminal, the error information corresponding to the unprovided error resolution method.
(((9)))
The image processing apparatus according to (((8))),
wherein the processor is configured to:
   when the unprovided error resolution method is not present, record print data and a setting of the information processing terminal in association with each other, the print data being data on which the print process has succeeded, the setting of the information processing terminal being a setting used at the success of the print process.
(((10)))
The Image Processing Apparatus According to (((9))),
wherein the processor is configured to:
   in response to a request from an information processing terminal different from the information processing terminal, provide, to the different information processing terminal, the recorded print data and the setting corresponding to the print data.
(((11)))
The image processing apparatus according to (((9))),
wherein the processor is configured to:
   in response to occurrence of the error in the print process on print data generated by an information processing terminal different from the information processing terminal, record print data and a setting of the different information processing terminal in association with each other, the recorded print data being among pieces of print data on which the print process has succeeded and being within a range predetermined as a range in which similarity to the print data on which the error has occurred is recognized, the setting of the different information processing terminal being used at the occurrence of the error; and
   provide, to the different information processing terminal, the recorded print data and the setting corresponding to the print data.
(((12)))
The image processing apparatus according to any one of (((1))) to (((11))),
wherein the error has occurred due to a mismatch in version between the image processing apparatus and the information processing terminal.
(((13)))
The image processing apparatus according to (((12))),
wherein the mismatch in version is a mismatch in the case where the version of the image processing apparatus is new and where the version of the information processing terminal is old.
(((14)))
The image processing apparatus according to (((13))),
wherein the version is a version of a driver, a version of application software, or a version of an operating system.
(((15)))
An information processing terminal comprising:
a processor configured to:
   generate print data on a basis of a user operation, and transmit the print data to an image processing apparatus;
   request, from the image processing apparatus, provision of an error resolution method on an error having occurred in a print process performed on the print data by the image processing apparatus;
   in response to provision of the error resolution method from the image processing apparatus, classify the error resolution method to a method which is capable of being applied before execution of the print process or a method which is not capable of being applied before execution of the print process; and
   take a measure according to the error resolution method which is capable of being applied before execution of the print process, and pend a measure taken according to the error resolution method which is not capable of being applied before execution of the print process.
(((16)))
An Image Processing System Comprising:
an image processing apparatus that performs a print process on print data generated by an information processing terminal,
wherein the image processing apparatus includes a configuration included in the image processing apparatus according to any one of (((1))) to (((11))).
(((17)))
The image processing system according to (((16))), further comprising:
an information processing apparatus that manages the image processing apparatus and the information processing terminal.
(((18)))

The image processing system according to (((17))),
wherein the error information and the error resolution method corresponding to the error information are recorded in either one or both of the image processing apparatus and the information processing apparatus.
(((19)))
A program causing a computer to execute a process, the computer controlling an image processing apparatus which performs a print process on print data generated by an information processing terminal, the process comprising:
recording error information and an error resolution method in association with each other, the error information being related to an error having occurred in the print process performed on the print data by the image processing apparatus, the error resolution method describing how to resolve the error in the information processing terminal; and
in response to occurrence of an error in the print process, provide, to the information processing terminal, the error resolution method corresponding to the error information for the error.
(((20)))
A program causing a computer to execute a process, the computer controlling an
information processing terminal, the process comprising: generating print data on a basis of a user operation, and transmitting the print data to an image processing apparatus;
requesting, from the image processing apparatus, provision of an error resolution method on an error having occurred in a print process performed on the print data by the image processing apparatus;
in response to provision of the error resolution method from the image processing apparatus, classifying the error resolution method to a method which is capable of being applied before execution of the print process or a method which is not capable of being applied before execution of the print process; and
taking a measure according to the error resolution method which is capable of being applied before execution of the print process, and pending a measure taken according to the error resolution method which is not capable of being applied before execution of the print process.

What is claimed is:

1. An image processing apparatus comprising:
a processor configured to:
record error information and an error resolution method in association with each other, the error information being related to an error having occurred in a print process performed on print data by the image processing apparatus, the print data being generated by an information processing terminal, the error resolution method describing how to resolve the error in the information processing terminal; and
in response to occurrence of an error in the print process, provide, to the information processing terminal, the error resolution method corresponding to the error information for the error.

2. The image processing apparatus according to claim 1,
wherein the error has occurred due to a mismatch in setting between the image processing apparatus and the information processing terminal.

3. The image processing apparatus according to claim 2,
wherein the mismatch in setting is a mismatch in the case where the setting of the image processing apparatus is correct and where the setting of the information processing terminal is not correct.

4. The image processing apparatus according to claim 3, wherein the setting is setting of a print parameter.

5. The image processing apparatus according to claim 3,
wherein the error resolution method is identified on a basis of the mismatch in setting between before and after resolution of the error in the information processing terminal which has succeeded in the error resolution.

6. The image processing apparatus according to claim 3,
wherein the processor is configured to:
in response to occurrence of the error in the print process on print data generated by an information processing terminal different from the information processing terminal, provide, to the different information processing terminal, the error resolution method corresponding to the error information for the error.

7. The image processing apparatus according to claim 3,
wherein the processor is configured to:
when the error resolution method corresponding to the error has not been recorded at a time of occurrence of the error, provide, to the information processing terminal, the error information for the error; and
record the error resolution method and the error information in association with each other, the error resolution method being identified from the mismatch in setting between before and after resolution of the error in the information processing terminal which has succeeded in resolving the error, the error information having been provided to the information processing terminal.

8. The image processing apparatus according to claim 3,
wherein the processor is configured to:
in response to a request from the information processing terminal, provide, to the information processing terminal, the error resolution method and the error information, the error resolution method being among the recorded error resolution methods and having not been provided to the information processing terminal, the error information corresponding to the unprovided error resolution method.

9. The image processing apparatus according to claim 8,
wherein the processor is configured to:
when the unprovided error resolution method is not present, record print data and a setting of the information processing terminal in association with each other, the print data being data on which the print process has succeeded, the setting of the information processing terminal being a setting used at the success of the print process.

10. The image processing apparatus according to claim 9,
wherein the processor is configured to:
in response to a request from an information processing terminal different from the information processing terminal, provide, to the different information processing terminal, the recorded print data and the setting corresponding to the print data.

11. The image processing apparatus according to claim 9,
wherein the processor is configured to:
in response to occurrence of the error in the print process on print data generated by an information processing terminal different from the information processing terminal, record print data and a setting of the different information processing terminal in association with each other, the recorded print data being among pieces of print data on which the print process has succeeded and being within a range predetermined as a range in which similarity to the print data on which the error has occurred is recognized, the setting of the different information processing terminal being used at the occurrence of the error; and
provide, to the different information processing terminal, the recorded print data and the setting corresponding to the print data.

12. The image processing apparatus according to claim 1,
wherein the error has occurred due to a mismatch in version between the image processing apparatus and the information processing terminal.

13. The image processing apparatus according to claim 12,
wherein the mismatch in version is a mismatch in the case where the version of the image processing apparatus is new and where the version of the information processing terminal is old.

14. The image processing apparatus according to claim 13,
wherein the version is a version of a driver, a version of application software, or a version of an operating system.

15. An information processing terminal comprising:
a processor configured to:
generate print data on a basis of a user operation, and transmit the print data to an image processing apparatus;
request, from the image processing apparatus, provision of an error resolution method on an error having occurred in a print process performed on the print data by the image processing apparatus;
in response to provision of the error resolution method from the image processing apparatus, classify the error resolution method to a method which is capable of being applied before execution of the print process or a method which is not capable of being applied before execution of the print process; and
take a measure according to the error resolution method which is capable of being applied before execution of the print process, and pend a measure taken according to the error resolution method which is not capable of being applied before execution of the print process.

16. An image processing system comprising:
an image processing apparatus that performs a print process on print data generated by an information processing terminal,
wherein the image processing apparatus includes a configuration included in the image processing apparatus according to claim 1.

17. An image processing system comprising:
an image processing apparatus that performs a print process on print data generated by an information processing terminal,
wherein the image processing apparatus includes a configuration included in the image processing apparatus according to claim 2.

18. The image processing system according to claim 16, further comprising:
an information processing apparatus that manages the image processing apparatus and the information processing terminal.

19. The image processing system according to claim 18,
wherein the error information and the error resolution method corresponding to the error information are recorded in either one or both of the image processing apparatus and the information processing apparatus.

20. A non-transitory computer readable medium storing a program causing a computer to execute a process, the computer controlling an information processing terminal, the process comprising:
generating print data on a basis of a user operation, and transmitting the print data to an image processing apparatus;
requesting, from the image processing apparatus, provision of an error resolution method on an error having occurred in a print process performed on the print data by the image processing apparatus;
in response to provision of the error resolution method from the image processing apparatus, classifying the error resolution method to a method which is capable of being applied before execution of the print process or a method which is not capable of being applied before execution of the print process; and
taking a measure according to the error resolution method which is capable of being applied before execution of the print process, and pending a measure taken according to the error resolution method which is not capable of being applied before execution of the print process.
